(19) United States
(12) Patent Application Publication
(10) Pub. No.: US 2016/0055473 A1
(43) Pub. Date: Feb. 25, 2016

(54) TRANSACTION DEVICE, TRANSACTION SYSTEM USING THE SAME AND TRANSACTION METHOD USING THE SAME

(71) Applicant: MIXTRAN INC., Hsin Chu (TW)

(72) Inventors: Yvette E-Wen Lin, Hsinchu (TW); Hsiu-Kang Chen, Hsinchu (TW); Lung-Chiu Chang-Hsu, Hsinchu (TW); Yu-Feng Chen, Hsinchu (TW)

(21) Appl. No.: 14/556,425

(22) Filed: Dec. 1, 2014

(30) Foreign Application Priority Data
Aug. 20, 2014 (TW) 103128552

(51) Int. Cl. G06Q 20/32

(52) U.S. Cl. CPC G06Q 20/32

(57) ABSTRACT

A transaction device, a transaction system using the same and a transaction method using the same are provided. The transaction device comprises a barcode scanner, an input unit and a verification unit. The barcode scanner is used for scanning a barcode image displayed in a mobile device. The input unit is used for receiving a verification code inputted by user after the barcode scanner scanned the barcode image. The verification unit is used for verifying whether the verification code inputted by the user is the same as an access code. If the verification code inputted by the user is the same as the access code, the verification unit outputs a verifying success signal.

This application claims the benefit of Taiwan application Serial No. 103128552, filed Aug. 20, 2014, the subject matter of which is incorporated therein by reference.

### BACKGROUND OF THE INVENTION

1. Field of the Invention

The invention relates in general to a transaction device, a transaction system using the same and a transaction method using the same, and more particularly to a transaction device requesting confirmation of a verification code before making payment, a transaction system using the same and a transaction method using the same.

2. Description of the Related Art

Mobile payment has been developed for many years. It is a future trend for business transactions to be done through a mobile phone. According to one transaction mode of the mobile payment, a transaction is directly completed after a barcode displayed on the mobile phone is scanned by a scanner.

However, such payment mold is not a reliable for user of the mobile phone. Once the barcode or the mobile phone was stolen before the payment is made, the stealer can perform transaction without the user's consent.

### SUMMARY OF THE INVENTION

The invention is directed to a transaction device, a transaction system using the same and a transaction method using the same. Before a payment is made, the user is requested to input a verification code to confirm the payment, hence reducing transaction risks.

According to one embodiment of the invention, a transaction device is provided. The transaction device comprises a barcode scanner, an input unit and a verification unit. The barcode scanner is used for scanning a barcode image displayed in a mobile device. The input unit is used for receiving a verification code inputted by user after the barcode scanner scans the barcode image. The verification unit is used for verifying whether the verification code inputted by the user is the same as an access code. If the verification code inputted by the user is the same as the access code, the method performs subsequent transaction process.

According to another embodiment of the invention, a transaction method is provided. The transaction method comprises following steps. A barcode image displayed in a mobile device is scanned by a transaction device. A user is requested by the transaction device to input a verification code after the barcode image displayed in a mobile device was scanned by the transaction device. Whether the verification code inputted by the user is the same as an access code is verified by the transaction device. If it is determined that the verification code inputted by the user is the same as the access code, the method performs subsequent transaction process.

According to an alternate embodiment of the invention, a transaction system is provided. The transaction system comprises a mobile device, a barcode scanner and a transaction device. The mobile device comprises a barcode generation unit and a display unit. The barcode generation unit is used for generating a barcode image. The display unit is used for displaying a barcode image. The barcode scanner is used for scanning the barcode image. The transaction device comprises an input unit and a verification unit. The input unit is used for receiving a verification code inputted by the user after the barcode scanner scanned the barcode image. The verification unit is used for verifying whether the verification code inputted by the user is the same as an access code. If the verification code inputted by the user is the same as the access code, the method performs subsequent transaction process.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1A illustrates a functional block diagram of a transaction system according to an embodiment of the invention;

FIG. 1B illustrates a flowchart of a transaction method using the transaction system of FIG. 1A;

FIG. 2 illustrates a functional block diagram of the transaction system of FIG. 1A according to another embodiment of the invention;

FIG. 3A illustrates a functional block diagram of a transaction system according to another embodiment of the invention;

FIG. 3B illustrates a flowchart of a transaction method using the transaction system of FIG. 3A;

FIG. 4A illustrates a functional block diagram of a transaction system according to another embodiment of the invention;

FIG. 4B illustrates a flowchart of a transaction method using the transaction system of FIG. 4A; and

FIG. 5 illustrates a functional block diagram of the transaction system of FIG. 4A according to another embodiment of the invention.

### DETAILED DESCRIPTION OF THE INVENTION

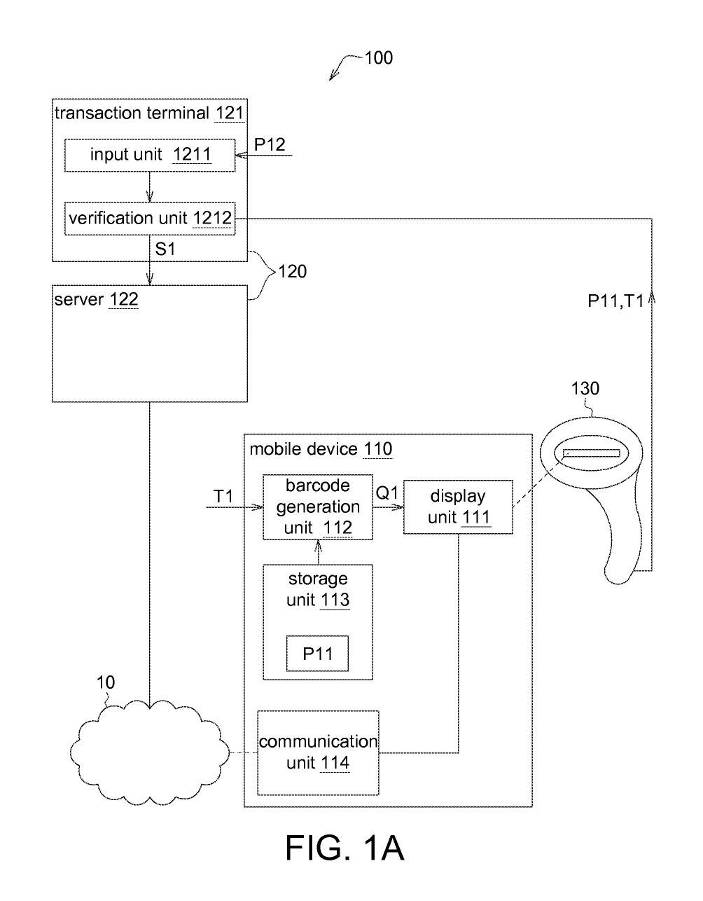

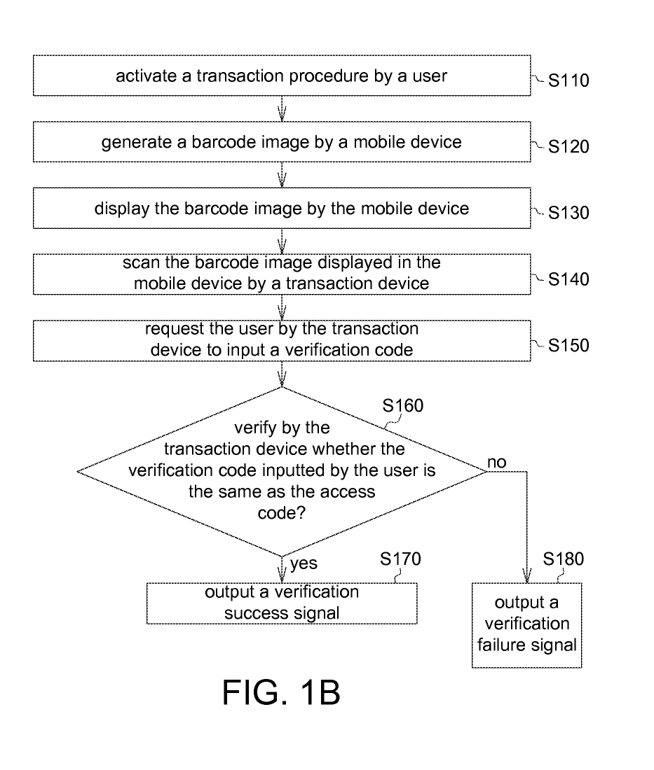

Refer to FIGS. 1A and 1B. FIG. 1A illustrates a functional block diagram of a transaction system according to an embodiment of the invention. FIG. 1B illustrates a flowchart of a transaction method using the transaction system of FIG. 1A.

As indicated in FIG. 1A, the transaction system 100 comprises a mobile device 110, a transaction device 120, a server 122 and a barcode scanner 130. The mobile device 110 may be realized by a portable electronic device such as mobile phone, personal digital assistant, and notebook computer. The mobile device 110 comprises a display unit 111, a barcode generation unit 112, a storage unit 113 and a communication unit 114. Functions of the abovementioned elements are described below.

The transaction device 120 and the barcode scanner 130 may form an electronic transaction platform such as a point of sale (POS) system. The electronic transaction platform may also be realized by a smartphone, a tablet PC or another device capable of reading image barcode and providing an interface via which the user may input an access code.

The transaction device 120 comprises a transaction terminal 121 and a server 122. The transaction terminal 121, such as a POS terminal, may comprise an input unit 1211 and a verification unit 1212. The server 122 maintains data of user's transaction account, such as account balance, identification and passwords.

In the present embodiment, the server 122 and the transaction terminal 121 are two separate devices. In another embodiment, the server 122 and the transaction terminal 121 may be integrated as one single device. In the present embodiment, since the server 122 and the transaction terminal 121 are configured on an existing POS network, a dedicated connection is established between the server 122 and the transaction terminal 121 to assure transaction safety. In another embodiment, the server 122 and the transaction terminal 121 may also be connected via public Internet. Under such circumstance, data transmission between the server 122 and the transaction terminal 121 needs to be protected through extra encryption. In an embodiment, the server 122 may further enhance security protection for transactions. Considering that the verification unit 1212 may be incapable of maintaining connectivity at all times, apart from the software already installed in the verification unit 1212, a secure verification chip or a hardware security module such as SAM card may also be embedded in the verification unit 1212 to perform off-line verification and satisfy various scenarios of use.

The server and the mobile device 110 may communicate via a mobile phone network 10 (or other wireless network). In an embodiment, the server 122 and the mobile device 110 may perform two-way communication via the mobile phone network 10. In another embodiment, the server and the mobile device 110 may perform one-way communication via the mobile phone network 10 to reduce the likelihood of communication interception in the mobile phone network 10 and reduce power consumption and communication cost for the mobile device 110.

Details of the process of making payment by using the transaction system of FIG. 1A are described below with accompanying drawings FIGS. 1A and 1B.

In step S110 of FIG. 1B, a transaction procedure is activated on a mobile device 110 by a user. For example, the user may buy or sell goods, top up his/her stored-value card or other types of transactions on webpage.

In step S120, a barcode image Q1 is generated by a barcode generation unit 112 of a mobile device 110 according to an access code P11 after the user activated a transaction procedure or is ready to make payment by using a transaction device 120. Before generating the barcode image Q1, a barcode generation unit 112 may firstly encrypt the access code P11, such that the access code P11 contained in the barcode image Q1 is an encrypted access code with enhanced security.

Here, the access code P11 may be such as user's ID card number, identification code of the mobile device or other passwords confirmed by the user. In the present embodiment, the access code P11 can be stored in a storage unit 113 of the mobile device 110. The storage unit 113 can be integrated into a smart patch or a storage element. The smart patch can be pasted onto a subscriber identity module (SIM) card and used for the purpose such as mobile payment, bank transaction, and communication. The storage element, such as memory card, pen drive, and hard disc, can be pluggably installed in the mobile device 110 through a slot or a universal serial bus (USB) port of the mobile device 110 or externally connected to an audio port of the mobile device 110. Specifically, the external storage element can be realized by a dongle.

Moreover, the barcode image Q1 may further contain transaction information T1 and an identification code of the mobile device 110. The transaction information T1 is such as transaction amount. The identification code of the mobile device 110 is used for identifying the mobile device 110 in a mobile phone network or a wireless network, such that the server 122 can transmit exclusive message to the designated mobile device 110. Let the mobile phone be taken for example. The identification code is such as an IMSI code, an IMEI code, a serial number of an SIM card and a mobile phone number, or a combination thereof. In other wireless network, the identification code is such as an MAC address or a specified IP address.

The barcode generation unit 112 may be realized by a circuit formed by a semiconductor process, and can be either integrated in or independent of a central processing unit (CPU) of the mobile device 110.

In step S130, after the barcode image Q1 was generated, the barcode image Q1 is displayed in the display unit 111 of the mobile device 110 to be scanned by a barcode scanner 130.

In step S140, when the user intends to make payment by using the mobile device 110, the barcode image Q1 displayed in the display unit 111 of the mobile device 110 is scanned by the barcode scanner 130 to access the access code P11, the transaction information T1 and the identification code of the mobile device 110 contained in the barcode image Q1.

In step S150, the user is requested by the transaction device 120 to input a verification code P12. For example, the input unit 1211 of the transaction terminal 121 is such as a touch screen on which an input column is displayed, and the user can input the verification code to the input column displayed on the touch screen. In another embodiment, the input unit 1211 of the transaction terminal 121 is such as a keyboard and the user can input the verification code P12 by pressing physical keys of the keyboard.

In an embodiment of the invention, after the barcode scanner 130 scanned the barcode image Q1 but before the payment is made, the transaction device 120 firstly requests the user to input the verification code P12, and will not perform subsequent transaction process unless the verification code P12 is verified as a correct code. Thus, transaction reliability can be enhanced, and unexpected transaction risks can be reduced. Under such design, even when the barcode image Q1 or the mobile device 110 is stolen, the stealer cannot complete the transaction without correct input of the verification code P12. In the present disclosure, “subsequent transaction process” refers to ordinary transaction process required for completing a transaction, such as security verification and/or deduction of account.

In step S160, after the user inputted the verification code P12, whether the verification code P12 inputted by the user is the same as the access code P11 is verified by the verification unit 1212 of the transaction device 120. If so, the method proceeds to step S170; otherwise, the method proceeds to step S180.

In the present embodiment, whether the verification code P12 inputted by the user is the same as the access code P11 is verified by the verification unit 1212 of the transaction terminal 121, but the embodiment of the invention is not limited thereto. The verification unit 1212 can be realized by a circuit formed by a semiconductor process, and can be either integrated in or independent of the CPU of the transaction terminal 121. In another embodiment, the verification unit 1212 can be integrated in the circuit formed by a semiconductor process and belonging to the transaction terminal 121 or integrated with software of a verification system, and may also be an external verifying device or system independent of the transaction terminal 121.

In step S170, if the verification code P12 inputted by the user is the same as the access code P11, a verifying success signal S1 is outputted to a server 122 by the verification unit 1212, wherein the server 122 performs subsequent transaction process after receiving the verifying success signal S1. In the subsequent transaction process, if the transaction is completed, the server 122 outputs a transaction confirmation message to a communication unit 114 of the mobile device 110, and the display unit 111 displays a transaction confirmation message to inform the user that the transaction is successfully completed.

In step S180, if the verification code P12 inputted by the user is not the same as the access code P11, a verification failure signal (not illustrated) is outputted to the server 122 by the verification unit 1212, the subsequent transaction process is terminated and a verification failure message is outputted to the communication unit 114 of the mobile device 110, and the display unit 111 accordingly displays a transaction failure message to inform the user that the transaction is not successful.

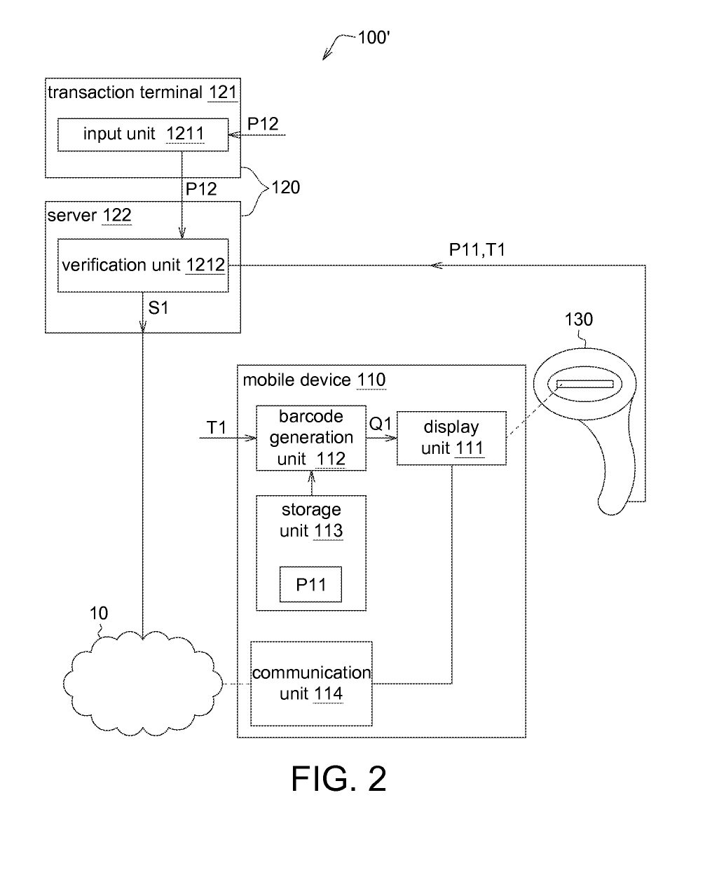

FIG. 2 illustrates a functional block diagram of the transaction system of FIG. 1A according to another embodiment of the invention. The transaction system 100′ comprises a mobile device 110, a transaction device 120, a server 122 and a barcode scanner 130. The mobile device 110 can be realized by a portable electronic device such as mobile phone, personal digital assistant, and notebook computer. The mobile device 110 comprises a display unit 111, a barcode generation unit 112, a storage unit 113 and a communication unit 114.

The transaction system 100′ of the present embodiment is different from the transaction system 100 of the above embodiment in that the verification unit 1212 of the transaction system 100′ is disposed in the server 122. Under such design, whether the verification code P12 inputted by the user is the same as the access code P11 is verified by the server 122. Besides, the verification unit 1212 can be integrated in the circuit formed by semiconductor process and belonging to the server 122, or integrated with software of a verification system, and may also be an external verifying device or system independent of the server 122.

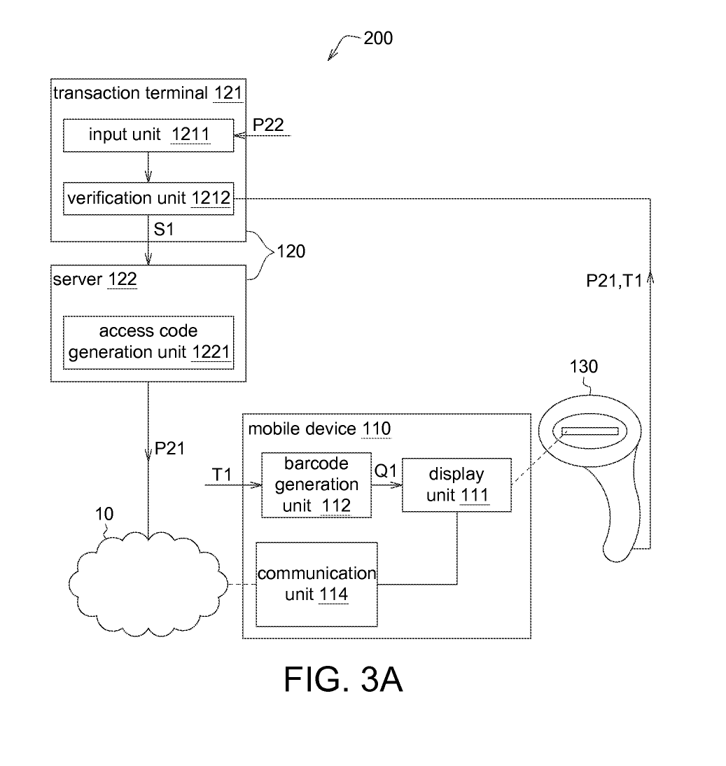

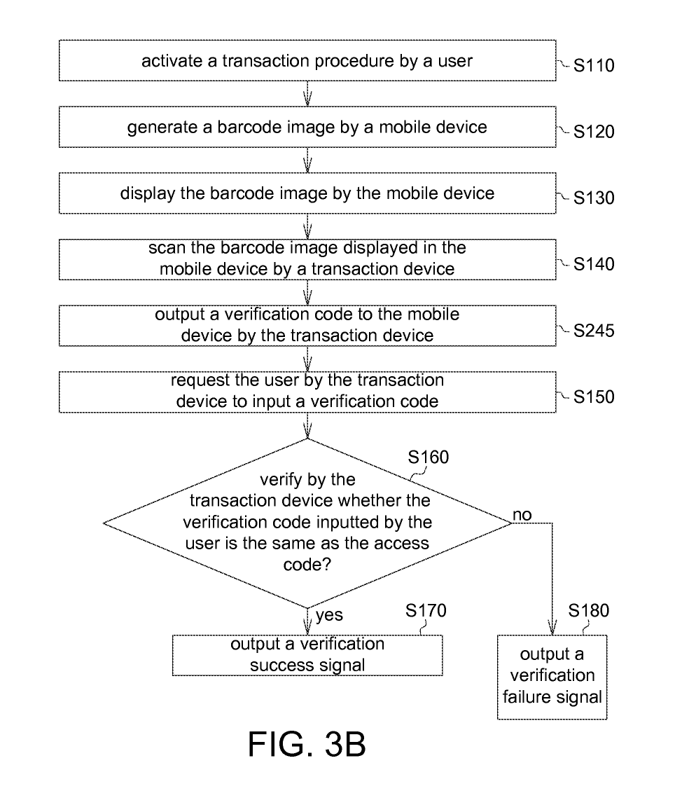

Refer to FIGS. 3A and 3B. FIG. 3A illustrates a functional block diagram of a transaction system according to another embodiment of the invention. FIG. 3B illustrates a flowchart of a transaction method using the transaction system of FIG. 3A.

As indicated in FIG. 3A, the transaction system 200 comprises a mobile device 110, a transaction device 120 and a barcode scanner 130. The transaction device 120 and the barcode scanner 130 may form an electronic transaction platform such as POS system. The electronic transaction platform may also be realized by a smartphone, a tablet PC or another device capable of reading image barcode and providing an interface via which the user may input an access code.

The transaction device 120 comprises a transaction terminal 121 and a server 122. The server 122 comprises an access code generation unit 1221 used for generating an access code P21. In another embodiment, the access code generation unit 1221 may be disposed in the transaction terminal 121. Under such design, the access code P21 is generated by the transaction terminal 121. In the present embodiment, the access code generation unit 1221 and the verification unit 1212 are respectively disposed in the server 122 and the transaction terminal 121. In another embodiment, the access code generation unit 1221 and the verification unit 1212 may be integrated as one single unit disposed in one of the transaction terminal 121 and the server 122. Besides, the access code generation unit 1221 may be realized by a circuit formed by a semiconductor process and may be either integrated in or independent of the transaction terminal 121.

Details of the transaction process of the transaction system 200 of FIG. 3A are described below with accompanying drawings FIGS. 3A and 3B. The transaction process of the transaction system 200 of the present embodiment is different from the transaction process of FIG. 1B in that: in the transaction process of the transaction system 200, the access code P21 is generated by the transaction device 120. Steps S110-S140 of FIG. 3B are already disclosed in the descriptions of the steps of FIG. 1B and are not repeated here. Descriptions of the transaction process of the transaction system 200 of FIG. 3A start with step S245.

In step S245, before the step S150 of requesting the user by the transaction device 120 to input the verification code, an access code P21 is firstly generated by the transaction device 120 and then the access code P21 is outputted to the mobile device 110 via the mobile phone network 10 and displayed by the display unit 111 of the mobile device 110. The access code P21 may be composed of at least one number and/or at least one symbol.

In step S150, the user is requested by the transaction device 120 to input a verification code P22. In an embodiment of the invention, before the payment is made, the transaction device 120 firstly requests the user to input the verification code P22, and will not perform subsequent transaction process unless the verification code P22 is verified as a correct code. Thus, transaction reliability may be enhanced, and unexpected transaction risks may be reduced. Under such design, even when the barcode image Q1 or the mobile device 110 is stolen, the stealer cannot complete the transaction without a correct input of the verification code P22.

In step S160, the access code P21 displayed by the display unit 111 and viewed by the user is used as a verification code by the user who further inputs the verification code to the transaction device 120, and after the user inputted the verification code P22, whether the verification code inputted by the user P22 is the same as the access code P21 generated by the access code generation unit 1221 is verified by the transaction device 120 (step S245). If so the method proceeds to step S170; otherwise, the method proceeds to step S180. In the present embodiment, whether the verification code inputted by the user P22 is the same as the access code P21 generated by the access code generation unit 1221 is verified by the verification unit 1212 of the transaction terminal 121. In another embodiment, the verification unit 1212 may be disposed in the server 122. Under such design, whether the verification code inputted by the user P22 is the same as the access code P21 generated by the access code generation unit 1221 is verified by the server 122.

In step S170, if the verification code inputted by the user P22 is the same as the access code P21 generated by the access code generation unit 1221 (step S245), a verifying success signal S1 is outputted to the server 122 by the verification unit 1212, and subsequent transaction process is performed by the server 122 accordingly. After the transaction is completed, a transaction confirmation message is transmitted to a communication unit 114 of the mobile device 110 by the server 122, and a transaction confirmation message is accordingly displayed by the display unit 111 to inform the user of the transaction state.

In step S180, if the verification code inputted by the user P22 is not the same as the access code P21 generated by the access code generation unit 1221 (step S245), a verification failure signal (not illustrated) is outputted to the server 122 by the verification unit 1212, and subsequent transaction process is accordingly terminated and a verification failure message is outputted to the communication unit 114 of the mobile device 110 by the server 122, and a transaction failure message is displayed by the display unit 111 accordingly inform the user of the transaction state.

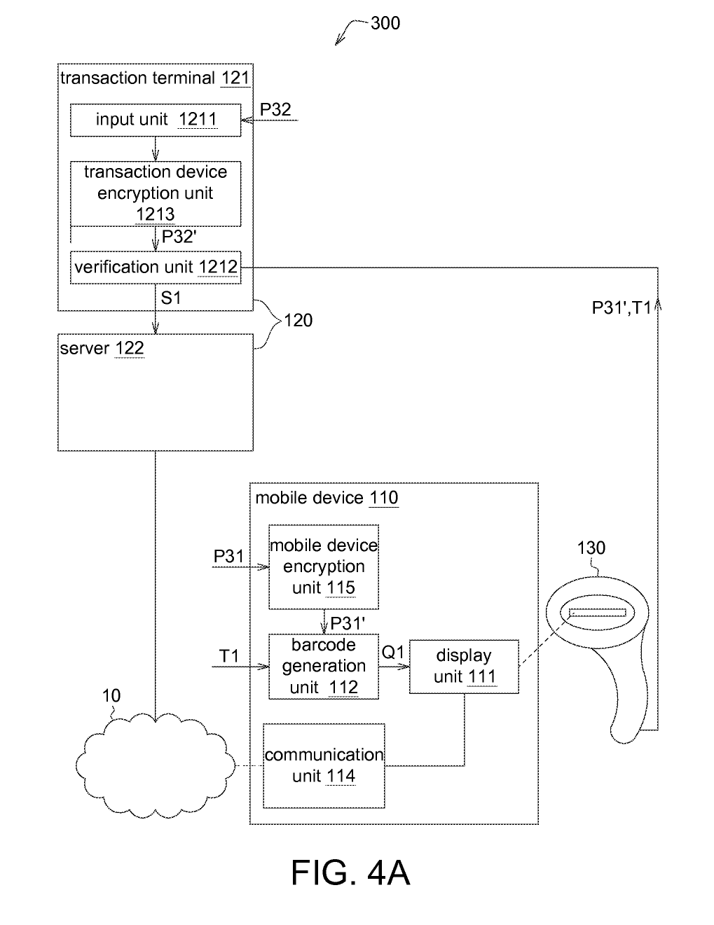

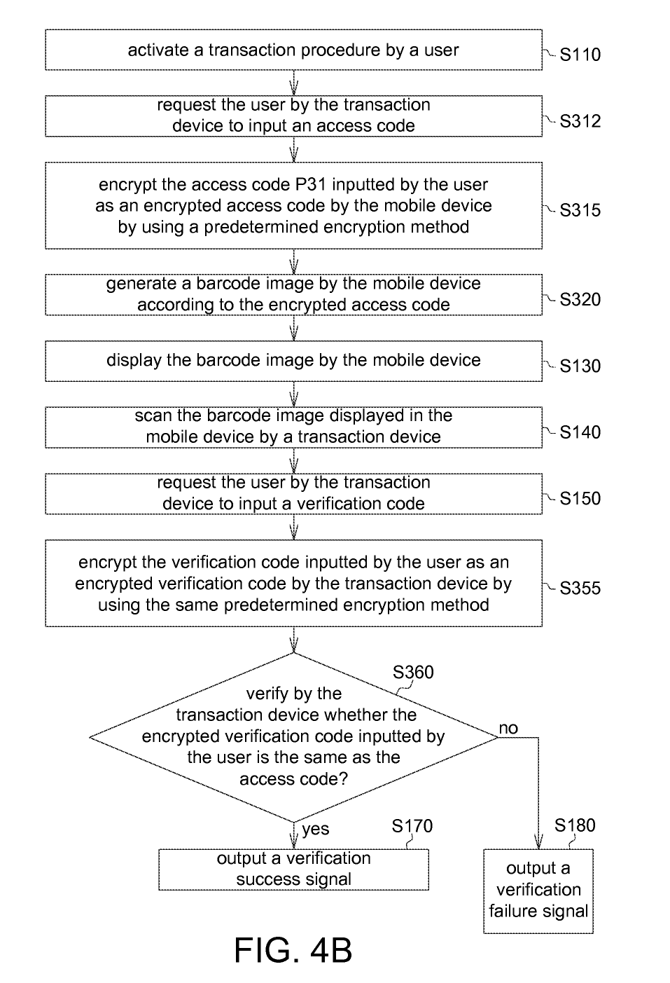

Refer to FIGS. 4A and 4B. FIG. 4A illustrates a functional block diagram of a transaction system according to another embodiment of the invention. FIG. 4B illustrates a flowchart of a transaction method using the transaction system of FIG. 4A.

As indicated in FIG. 4A, the transaction system 300 comprises a mobile device 110, a transaction device 120 and a barcode scanner 130. The transaction device 120 and the barcode scanner 130 may form an electronic transaction platform, such as a POS system. The electronic transaction platform may also be realized by a smartphone, a tablet PC or another device capable of reading image barcode and providing an interface via which the user may input an access code.

The transaction device 120 comprises a transaction terminal 121 and a server 122. The transaction terminal 121 comprises an input unit 1211, a verification unit 1212 and a transaction device encryption unit 1213. In the present embodiment, the verification unit 1212 and the transaction device encryption unit 1213 together are disposed in the transaction terminal 121, but the embodiment of the invention is not limited thereto. Besides, the transaction device encryption unit 1213 may be realized by a circuit formed by a semiconductor process, and may be either integrated in or independent of the CPU of the transaction terminal 121.

Details of the transaction process of the transaction system 300 of FIG. 4A are described below with accompanying drawings FIGS. 4A and 4B. Unlike the transaction process of FIG. 3B, the access code P31 of the present embodiment is inputted by the user by using the mobile device 110. Details are disclosed below.

In step S110, a transaction procedure is activated on a mobile device 110 by a user.

In step S312, after the user activated a transaction procedure or is ready to make payment, the user is requested by the mobile device 110 to input an access code P31 for verifying payment in subsequent step (step S150). The access code P31 may be composed of at least one number and/or at least one symbol inputted by the user.

In step S315, the access code P31 inputted by the user through an input unit (not illustrated) of the mobile device 110 is encrypted as an encrypted access code P31′ by the mobile device encryption unit 115 of the mobile device 110 by using a predetermined encryption method, wherein the input unit may be realized by a physical keyboard or a touch screen. After the user inputted the access code P31, the access code inputted by the user P31. The predetermined encryption method is such as hashing algorithm, symmetric encryption algorithm and asymmetric encryption algorithm. The hashing algorithm is such as message-digest algorithm 5 (MD5) and secure hash algorithm (Sha-1). The symmetric algorithm is such as data encryption standard (DES), triple DES (3-DES) and advanced encryption standard (AES). The asymmetric algorithm is such as RSA algorithm. Besides, the mobile device encryption unit 115 may be realized by a circuit formed by a semiconductor process, and may be either integrated in or independent of a CPU of the mobile device 110.

In step S320, a barcode image Q1 is generated by the barcode generation unit 112 of the mobile device 110 according to the encrypted access code P31′, wherein the barcode image Q1 may contain transaction information T1 and identification code of the mobile device 110.

In step S130, after the barcode image Q1 is generated, the barcode image Q1 is displayed on the display unit 111 of the mobile device 110 to be scanned by the barcode scanner 130.

In step S140, the barcode image Q1 displayed in the display unit 111 of the mobile device 110 is scanned by the barcode scanner 130 to access the access code P11, the transaction information T1 and the identification code of the mobile device 110 that are contained in the barcode image Q1.

In step S150, the user is requested by the transaction device 120 to input a verification code. In an embodiment of the invention, before the payment is made, the user is firstly requested by the transaction device 120 to input a verification code P32, and subsequent transaction process will not be performed unless the verification code P32 is verified as a correct code. Thus, transaction reliability may be enhanced, and unexpected transaction risks may be reduced. Under such design, even when the barcode image Q1 or the mobile device 110 is stolen, the stealer cannot complete the transaction without a correct input of the verification code P32.

In step S355, the verification code inputted by the user P32 is encrypted as an encrypted verification code P32′ by the transaction device encryption unit 1213 of the transaction device 120 by using the same predetermined encryption method.

In step S360, whether the encrypted verification code P31′ is the same as the encrypted access code P32′ is verified by the verification unit 1212 of the transaction device 120. If so, the method proceeds to step S170; otherwise, the method proceeds to step S180.

Subsequent steps S170 and S180 are already described in FIGS. 1B and 3B and are not repeated here.

According to the transaction method disclosed in above embodiments of the invention, the user is requested by the transaction device 120 to input an access code after the barcode image Q1 displayed on the mobile device 110 was scanned by the barcode scanner 130 but before the payment is made, such that transaction reliability may be enhanced and unexpected transaction risks may be reduced. The access code may be stored in an internal element of the mobile device 11 (such as a smart patch or an SIM card), stored in a pluggable storage device (such as a memory card, a pen drive and a hard disc), generated by the transaction device 120 or inputted by the user through the mobile device 110. Besides, the access code may be composed of at least one number, at least one symbol, and at least one English letter.

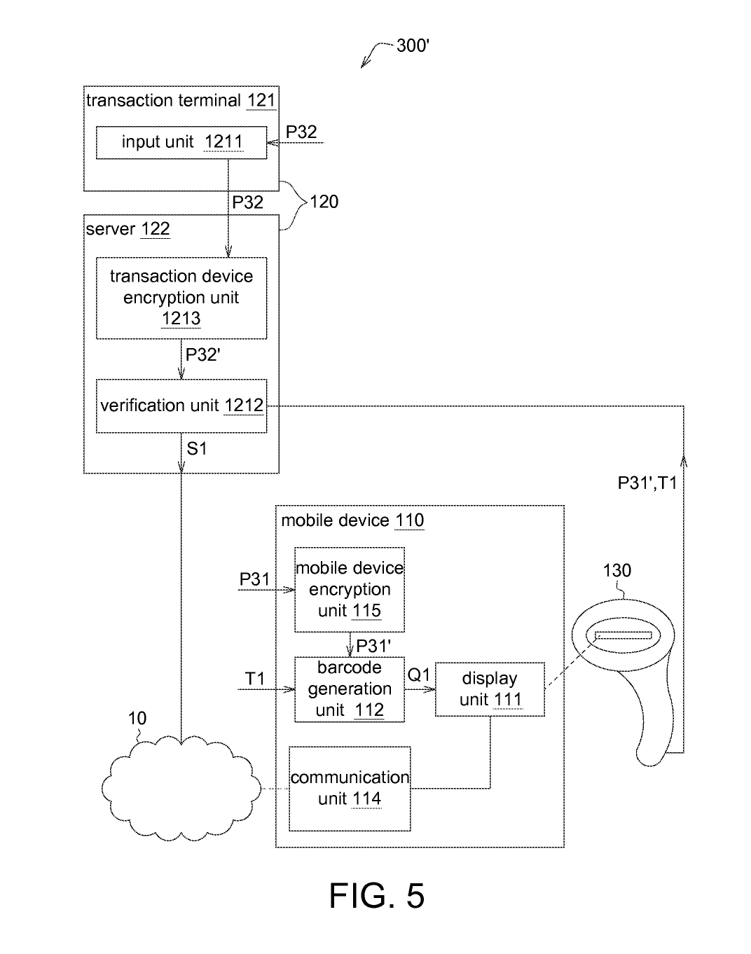

FIG. 5 illustrates a functional block diagram of the transaction system of FIG. 4A according to another embodiment of the invention. The transaction system 300′ comprises a mobile device 110, a transaction device 120 and a barcode scanner 130. The transaction device 120 and the barcode scanner 130 may form an electronic transaction platform, such as a POS system. The electronic transaction platform may also be realized by a smartphone, a tablet PC or another device capable of reading image barcode and providing an interface via which the user may input an access code.

The transaction device 120 comprises a transaction terminal 121 and a server 122. The transaction system 300′ of the present embodiment is different from the transaction system 300 of above embodiments in that: the verification unit 1212 and the transaction device encryption unit 1213 together are disposed in the server 122. Under such design, the server 122 encrypts the verification code inputted by the user P32 is encrypted as an encrypted verification code P32′ and whether the verification code P12 inputted by the user is the same as the access code P11 is further verified.

In addition, the verification unit 1212 and the transaction device encryption unit 1213 may be integrated in a circuit formed by the semiconductor process of the server 122 or integrated in software of a verification system. The verification unit 1212 and the transaction device encryption unit 1213 may be realized by an external verifying device or system independent of the server 122. In another embodiment, the verification unit 1212 and the transaction device encryption unit 1213 may be realized by software of an encryption system, or an external verifying device or system independent of the server 122.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A transaction device, comprising:
a barcode scanner used for scanning a barcode image displayed in a mobile device;
an input unit used for receiving a verification code inputted by user after the barcode scanner scans the barcode image; and
a verification unit used for verifying whether the verification code inputted by the user is the same as an access code, and if the verification code inputted by the user is the same as the access code, the method performs subsequent transaction process.

2. The transaction device according to claim 1, wherein the access code is stored in the mobile device or a pluggable storage device.

3. The transaction device according to claim 1, further comprising:
an access code generation unit used for generating the access code and outputting the access code to the mobile device before whether the verification code inputted by the user is the same as the access code is verified.

4. The transaction device according to claim 1, wherein the barcode image contains an encrypted access code encrypted by using a predetermined encryption method, and the transaction device further comprises:
a transaction device encryption unit used for encrypting the verification code inputted by the user as an encrypted verification code by using the same predetermined encryption method;
wherein, the verification unit is used for verifying whether the encrypted verification code is the same as the encrypted access code.

5. A transaction method, comprising:
scanning a barcode image displayed in a mobile device by a transaction device;
requesting the user by the transaction device to input a verification code after the transaction device scanned the barcode image displayed in the mobile device;
verifying, by the transaction device, whether the verification code inputted by the user is the same as an access code; and
performing subsequent transaction process if the verification code inputted by the user is the same as the access code.

6. The transaction method according to claim 5, wherein the access code is stored in the mobile device or a pluggable storage device.

7. The transaction method according to claim 5, before the step of requesting the user by the transaction device to input a verification code, the transaction method further comprises:
outputting the access code to the mobile device by the transaction device.

8. The transaction method according to claim 5, wherein before the step of scanning the barcode image displayed in the mobile device by the transaction device, the transaction method further comprises:
requesting the user by the mobile device to input the access code;
encrypting the access code inputted by the user as an encrypted access code by the mobile device by using a predetermined encryption method;
generating the barcode image by the mobile device according to the encrypted access code, such that the barcode image contains information of the encrypted access code;
displaying the barcode image by the mobile device;
before the step of verifying, by the transaction device, whether the verification code inputted by the user is the same as the access code, the transaction method further comprises:
encrypting the verification code inputted by the user as an encrypted verification code by the transaction device by using the same predetermined encryption method;
verifying, by the transaction device, whether the encrypted verification code is the same as the encrypted access code in the step of verifying whether the verification code inputted by the user is the same as the access code by the transaction device.

9. A transaction system, comprising:
a mobile device, comprising:
a barcode generation unit used for generating a barcode image; and
a display unit used for displaying the barcode image;
a barcode scanner used for scanning the barcode image; and
a transaction device, comprising:
an input unit used for receiving a verification code inputted by the user after the barcode scanner scanned the barcode image; and
a verification unit used for verifying whether the verification code inputted by the user is the same as an access code, and if the verification code inputted by the user the same as the access code, the method performs subsequent transaction process.

10. The transaction system according to claim 9, wherein the mobile device further comprises:
a storage unit storing the access code.

11. The transaction system according to claim 9, wherein the access code stores is stored in a pluggable storage device.

12. The transaction system according to claim 9, wherein the transaction device further comprises:
an access code generation unit used for generating the access code and outputting the access code to the mobile device before verifying whether the verification code inputted by the user is the same as the access code.

13. The transaction system according to claim 9, wherein the mobile device requests the user to input the access code before the barcode scanner scanned the barcode image displayed in the mobile device;
the mobile device further comprises:
a mobile device encryption unit used for encrypting the access code inputted by the user as an encrypted access code by using a predetermined encryption method;
wherein, the barcode generation unit is used for generating the barcode image according to the encrypted access code, such that the barcode image contains the encrypted access code;
the transaction device further comprises:
a transaction device encryption unit used for encrypting the verification code inputted by the user as an encrypted verification code by using the same predetermined encryption method before the verification unit verifies whether the verification code inputted by the user is the same as the access code;
wherein, the verification unit is used for verifying whether the encrypted verification code is the same as the encrypted access code.

14. The transaction system according to claim 9, wherein the access code is identification number of the mobile device or user's ID card number.
